(19) United States
(12) Patent Application Publication
(10) Pub. No.: US 2012/0102579 A1
(43) Pub. Date: Apr. 26, 2012

(54) METHOD FOR CONTROLLING UNAUTHORIZED SOFTWARE APPLICATION USAGE

(76) Inventor: Mandar Patil, Pune (IN)

(21) Appl. No.: 13/381,723

(22) PCT Filed: Jun. 30, 2010
(86) PCT No.: PCT/IB10/52978

§ 371 Date: Dec. 30, 2011

(30) Foreign Application Priority Data
Jul. 1, 2009 (IN) 1544/MUM/2009

(51) Int. Cl. G06F 7/04

(52) U.S. Cl. 726/30; 726/26

(57) ABSTRACT

According to the present invention there is provided a method to ensure authorized usage of software, by creating and then verifying and validating with the software's registered information in the vendor's online server, at frequent intervals, software activation file and computer's motherboard id.

### DESCRIPTION OF THE INVENTION

Present invention describes online registration, activation and reinstallation program, said program is a byte code program written in Microsoft .NET programming language.

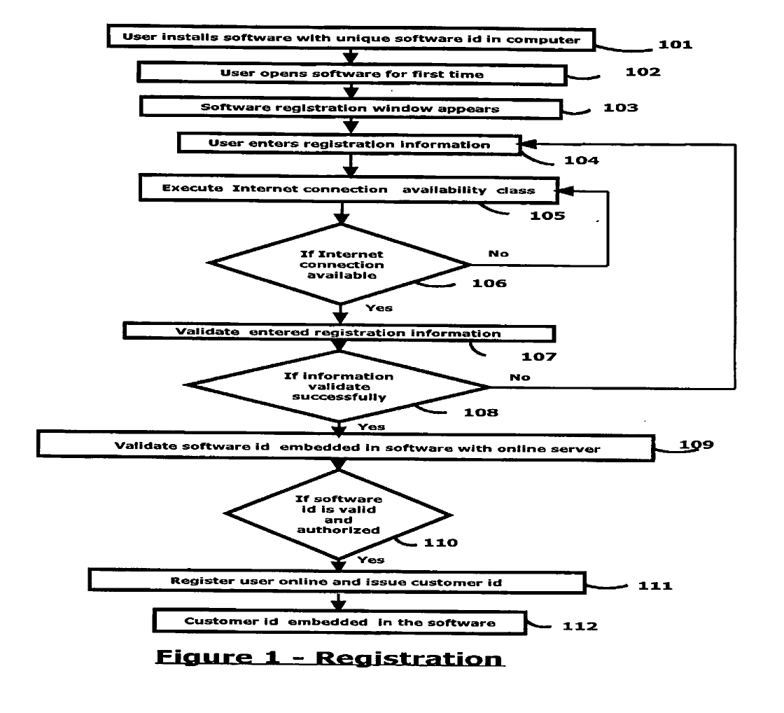

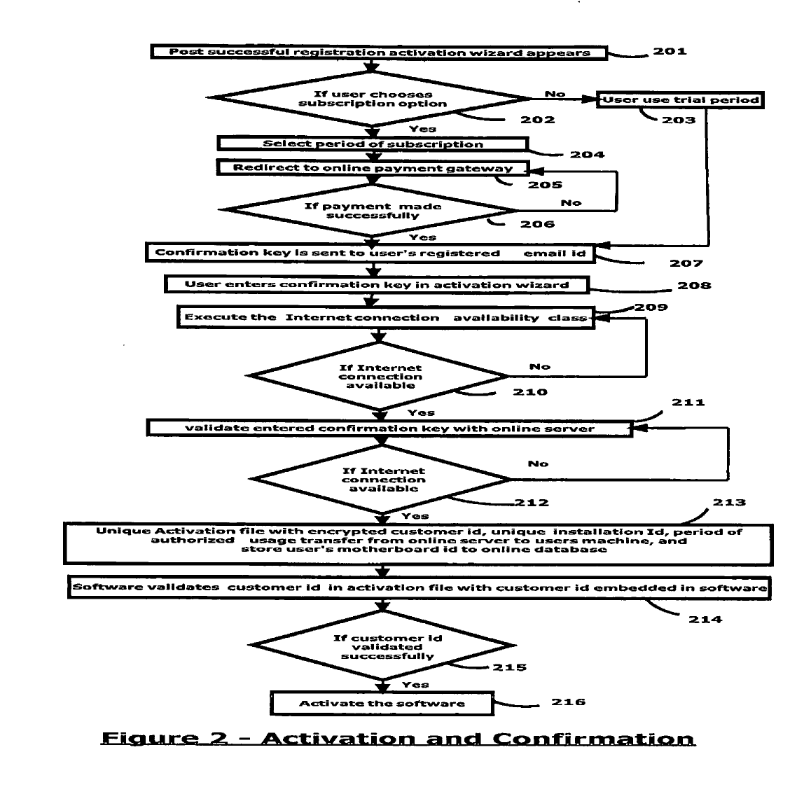

Referring to FIG. 1, User installs the software with embedded unique software id to his computer by executing function 101, upon successful installation user is ready to use the software. User click on the software executable for first time to run the software, method 102 is invoked. As user use the software for first time software registration 103 window will appear to register user to online server from desktop software. User enters his registration information 104 into registration wizard 103. If internet connection is available 105 verifies the integrity of the 105 method associated with each loaded object, if the method 106 is successfully executed the method 107 validates registration information upon successful invocation of 108. Software validates the software id embedded in software with the software id registered at online server by executing function 109, Validator 110 is executed to validate whether the software id is valid and authorized. Software register user to the online server by invoking method 111 and issue unique customer id to the user and embed customer id in the software by executing method 112.

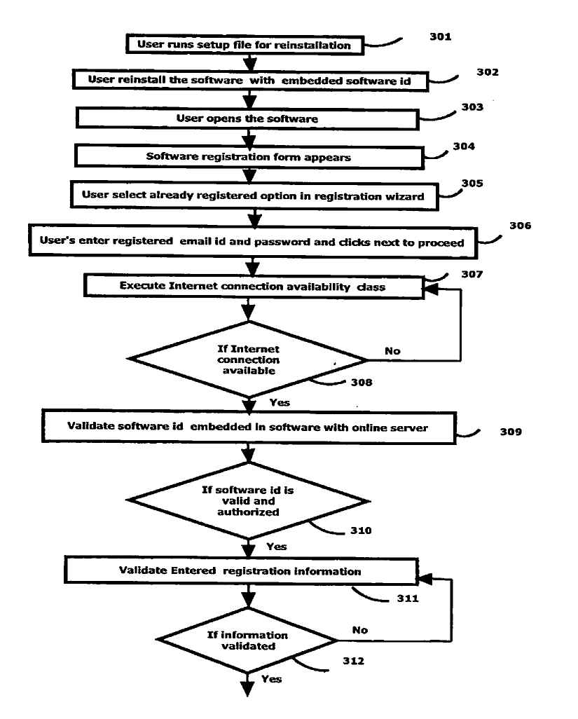

Referring to FIG. 2, as user install and register the software to online server user need to enter confirmation key to activate the software. Method 201 is invoked to display activation wizard, user choose subscription option i.e. trial or subscription by invoking method 202, If user select trial period 203 confirmation key will be send to user's registered email id. If user selects subscription option by performing method 204 software redirect to online payment gateway 205, if user made payment successfully by invoking method 206 software send confirmation key to user's registered email id by invoking method 207. user enters confirmation key into activation key by executing function 208, software execute internet connection availability class 209 to check the internet connection if internet is available 210 then function 211 execute to validate the confirmation key with the online database by executing internet availability class 212. Upon successful validation server send activation file with encrypted customer id 213, this activation file also contain installation id, period of authorized usage transferred from online server to user's machine and store users motherboard id to online database. Software validates customer id in activation file with customer id embedded in software by executing function 214. If customer id validated successfully 215 method 216 executed to activate the software.

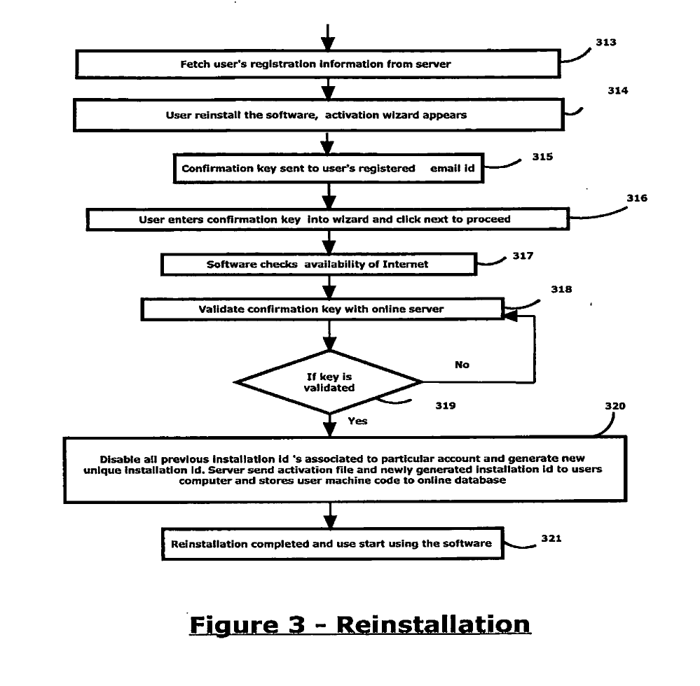

Referring to FIG. 3a, If the software is needed to be reinstalled, method 301 is invoked. User reinstalls the software with embedded unique software id by executing function 302. Method 303 is executed while user clicks to start the software, software registration window 304 appears, user selects whether this is new installation or reinstallation of an existing software, If user selects reinstallation, click next to proceed by executing function 305. User enters email id and password into the wizard and click next by performing function 306, If internet connection is available 307 verifies the integrity of the 308 method associated with each loaded object, if the method 308 is successfully verified 309 is invoked to validate the software id embedded in software with the software id registered at online server, Validator 310 is executed to validate whether the software id is valid and authorized.

Method 311 is 311 to check entered information with online server database. If entered information is present 312 verifies the integrity of the 312 method associated with each loaded object, if the method 312 is successfully verified 313 (as referred in FIG. 3b) is invoked to fetch all information of user who has already registered to online server. Method 314 reinstalls the software. If method 314 executed successfully, then software sends confirmation key to the user's registered email id by performing 315. User enters confirmation key into the activation wizard by executing function 316. Software checks the availability of internet by performing method 317. Software validates confirmation key 318 with online server database, if key is validated by method 319 then disable all previous installation ids associated with the particular account and generates new unique installation id and store machine code to online database by executing function 320, the method 321 called to complete the reinstallation of software.

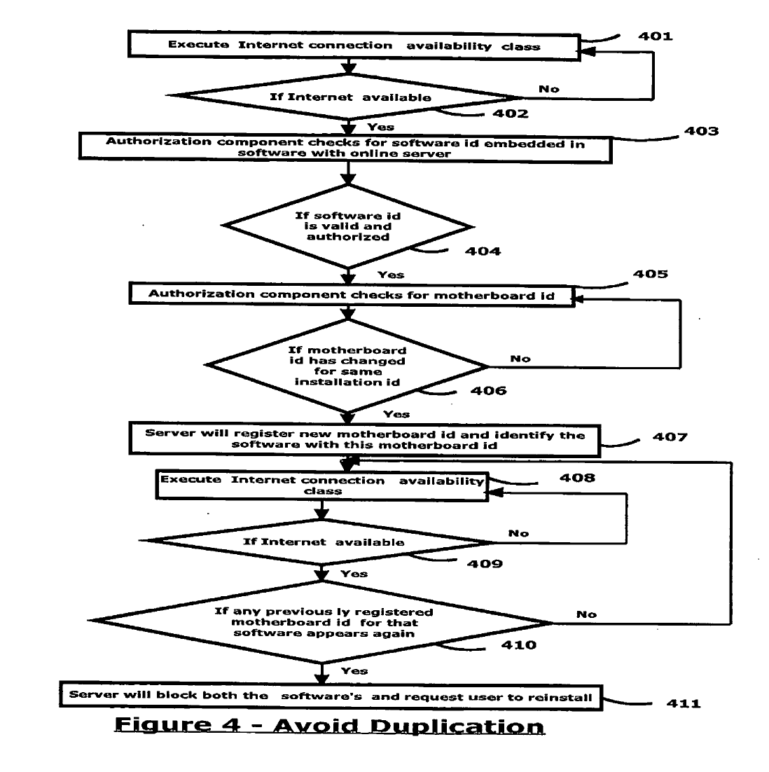

Referring to FIG. 4, as user uses the software, periodically computers motherboard id is validated with the motherboard id registered online during activation. Internet availability function 401 is invoked to execute internet availability class, if function 402 executed successfully. 403 is invoked to validate the software id embedded in software with the software id registered at online server, Validator 404 is executed to validate whether the software id is valid and authorized. The authorization component 405 checks the motherboard id. If the motherboard id mismatch, there could be two reasons first that user has changed the hardware, and the second reason because the software has been duplicated. Method 406 verifies the integrity of the methods associated with each loaded object, if the method successfully checks change in motherboard id then method 407 is invoked to register new motherboard id and identify the software with this motherboard id. If internet connection is available 408 verifies the integrity of the 408 method associated with each loaded object, if the method 409 is successfully verified 410 is invoked to check if any previously registered motherboard id appears again for that software, if the motherboard id appears again, function 411 invoked and server will block both the software and request user to reinstall.

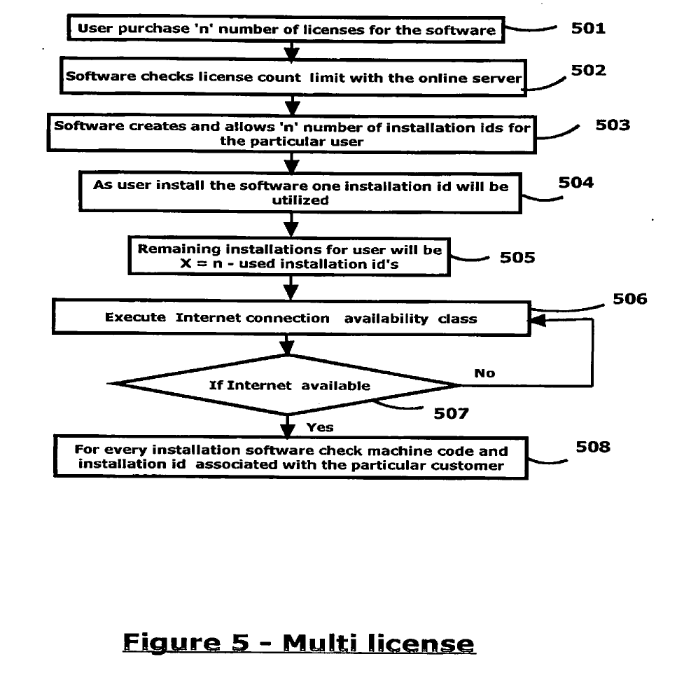

Referring to FIG. 5, If user purchases ‘n’ number of licenses for the software by invoking function 501. As user installs the software and register the software with online server, software checks license count limit for the particular user with the online server database by invoking the function 502. Software invokes the method 503 to create ‘n’ number of installation ids for that particular user and method 504 associate these installation id's to the customer id of that user. As user installs the software one installation id will be utilized for the installation by executing function 505. By invoking method 506 software records these transactions date wise to online server database. If internet connection available after executing function 507 and 508 checks motherboard id and installation id associated with the particular user for every installation.

I claim:

1. A method to ensure authorized usage of software by creating and then verifying and validating online, at frequent intervals with the registered information in the vendor's online server, software activation file comprising of a unique permanent customer id, registered email id, software id, installation id, period of authorized usage of software and computer's motherboard id.

2. A method of claim 1 wherein, the software is activated after the confirmation key is entered in the software activation wizard. The said key confirms that the activation file being created for the particular software which has requested for activation.

3. A method of claim 1 wherein, an installation id creates a unique identity of each installation/reinstallation of a particular software registered with the vendors online server.

4. A method of claim 1 wherein, the motherboard id is used to create a uniqueness of the computer in which the software is installed.

5. A method of claim 1 wherein, the software is registered with the vendor's online server on the user's email id and a unique id related to the category of said software developed by the vendor. The said unique id is not always necessary and registration of the software can be done on the email id alone too.

6. A method of claim 1 wherein, the authorization component matches the installation id, motherboard id, software id, customer id and period of authorized usage, expiry date of the software with the vendor's online server, upon its connection to the internet.

7. A method of claim 1, wherein, the motherboard id of the computer is registered with the vendor's online server which would enable the authorization component to perform the necessary validations with respect to the authorization of the software on the particular computer where the software is installed.

8. A method of claim 2 wherein, an improvised software reinstallation process is automated and hassle free and is easy for the user to reinstall when needed.

9. A method of claim 1 wherein, if the said software is reinstalled, a new installation id is generated and stored in the software and the vendor's online server and the previous installation id is disabled ensuring that at any point of time only one unique and registered software per account, on a single computer exists which has only one machine id and only one installation id at any point of time

10. A method of claim 1 wherein, only allowed and authorized number of softwares licenses per account can exist.

11. A method of claim 1 wherein, the software registration is only a one time process, at the time of installation, per unique email id and next time same software can only be reinstalled using the same registration information.

12. A method of claim 1, wherein, whenever the software get connected to the internet, the vendor's online server issues to the software a next date of online validation with a reminder appearing in software, alerting the user to connect to the internet for validation as a cyclic process occurring periodically in trial and in paid subscription modes; if a change is found in the motherboard id, the vendor's online server keeps a note of said new id and if previously registered motherboard id appears again while further validations, the vendor's online server blocks the software and both the motherboard ids will be no longer recognized by the server. Further a reinstallation request will be sent to the registered user. Even if the software does not connect to the internet within the stipulated time, the software gets blocked for usage until further connection to vendor's online server.

13. A method of claim 1 wherein, each installable of the software contains an associated unique software id which helps vendor manage a particular installation and said server contains all information related to the version of the software, registration information, installation date and the number of installations occurred through particular software id associated with said software id.

14. A method of claim 1 which enables the software vendor to obtain full control over every software installation, reinstallation and usage of each software when connected to vendor's online server preventing unauthorized usage of the software.

15. A method of claim 1 wherein, the vendors online server validates the software id during registration, reinstallation and online verification of each software and if the software id identified in the software does not appear to be in the authorized list and valid list of the software id's on the server, vendor's online server blocks the further process and usage of software.
